(19) United States
(12) Patent Application Publication
(10) Pub. No.: US 2024/0333840 A1
(43) Pub. Date: Oct. 3, 2024

(54) VERIFYING A COMMUNICATION CHANNEL BEING OPEN AND USABLE

(71) Applicant: International Business Machines Corporation, Armonk, NY (US)

(72) Inventors: Hyman David Chantz, Scarsdale, NY (US); Robert Lynch, Bedminster, NJ (US); Elijah Swift, Poughkeepsie, NY (US)

(21) Appl. No.: 18/126,710

(22) Filed: Mar. 27, 2023

(51) Int. Cl. H04M 7/12; H04L 65/1069

(52) U.S. Cl. CPC H04M 7/1295; H04L 65/1069

(57) ABSTRACT

A method, system and computer program product for verifying a communication channel (e.g., radio channel) being open and usable. A query of one or more dual-tone multi-frequency signals (DTMF signals) is transmitted by a transmitting device (e.g., handheld radio device), such as a transmitting device operated by a first responder, over a communication channel (e.g., radio channel) to a receiving device (e.g., handheld radio device), such as a receiving device operated by a different first responder. Such first responders utilize a “voice grade” channel (frequency range of 300 to 3,000 Hz) to communicate, which is used by the transmitting device to transmit the query of one or more DTMF signals. An acknowledgement of a reception of the query of one or more DTMF signals from the receiving device is received by the transmitting device thereby verifying that the communication channel (e.g., radio channel) is open and usable.

### TECHNICAL FIELD

The present disclosure relates generally to mission critical communications, and more particularly to verifying a communication channel (e.g., radio channel) being open and usable, such as for essential personnel (e.g., first responders).

### BACKGROUND

During times of crisis or emergency, reliable public safety communications are crucial not only to help first responders (someone designated or trained to respond to an emergency) save lives but also to help keep first responders safe, improve response time and interagency coordination. Public safety teams rely on mission critical communications solutions in order to carry out their missions.

### SUMMARY

In one embodiment of the present disclosure, a method for verifying a communication channel being open and usable comprises transmitting a query of one or more dual-tone multi-frequency signals over the communication channel to a receiving device. The method further comprises receiving an acknowledgment of a reception of the query of the one or more dual-tone multi-frequency signals from the receiving device thereby verifying the communication channel is open and usable.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates the 697 Hz-1633 Hz dual framework utilized by handheld radio devices to determine if a communication channel is open and usable in accordance with an embodiment of the present disclosure;

FIG. 3 illustrates the basic components of a handheld radio device in accordance with an embodiment of the present disclosure;

FIG. 4 illustrates the basic components of a mobile device in accordance with an embodiment of the present disclosure;

FIG. 5 illustrates an embodiment of the present disclosure of the hardware configuration of the handheld radio device configured as a push-to-talk (PTT) device which is representative of a hardware environment for practicing the present disclosure;

FIG. 6 is a flowchart of a method for verifying that a communication channel is open and usable for essential personnel in accordance with an embodiment of the present disclosure;

FIG. 7 is a diagram illustrating manually entering dual-tone multi-frequency signals by the originator and recipient in accordance with an embodiment of the present disclosure;

FIG. 8 is a diagram illustrating the automatic generation of tone sequences by the originator and/or the recipient in accordance with an embodiment of the present disclosure;

FIG. 9 is a diagram illustrating the use of a mobile device to provide a redundant, parallel channel of the acknowledgement in accordance with an embodiment of the present disclosure; and

FIG. 10 is a diagram illustrating the verification of the status of a device in communication with the receiving device in accordance with an embodiment of the present disclosure.

### DETAILED DESCRIPTION

As stated in the Background section, during times of crisis or emergency, reliable public safety communications are crucial not only to help first responders (someone designated or trained to respond to an emergency) save lives but also to help keep first responders safe, improve response time and interagency coordination. Public safety teams rely on mission critical communications solutions in order to carry out their missions.

Mission critical communications encompass a wide range of solutions that include a mix of devices, equipment, systems, and infrastructure that enable first responders and others to communicate efficiently and effectively in the field.

Mission critical communications provide the ability to coordinate response activities, helping to keep teams connected, communicating, and informed. Without the right mix of public safety communications, lives could be at stake.

Since the 1930s, mission critical communications have relied mainly on land mobile radio (LMR). LMR systems consist of handheld radios (also known as “push-to-talk”), vehicle radios, base station radios, networks, and repeaters.

However, in recent years, mission critical communication network providers have begun including new solutions, devices, equipment, and infrastructure that provide greater resiliency. Thanks to the rise of satellite networks, long term evolution (LTE) networks, such as FirstNet, and 4G and 5G broadband, mission critical networks now support: push-to-video, video sharing, file sharing, GPS location sharing, laptop computers, tablets, wireless earpieces, etc.

Unfortunately, communication failures have occurred in such mission critical communication networks due in part to the use of disparate communication networks and difficulties in establishing end-to-end communications. In particular, communication failures result from not being able to verify a communication channel (e.g., logical connection over a multiplexed medium, such as a radio channel in telecommunications and computer networking) as being open and usable. For example, at times, it has become unclear as to whether first responders (e.g., firefighters) have received mandatory evacuation orders.

The embodiments of the present disclosure provide a means for reducing communication failures in mission critical communication networks by verifying that a communication channel (e.g., radio channel) is open and usable for essential personnel (e.g., first responders). In one embodiment, a communication channel is verified as being open and usable for essential personnel (e.g., first responders) by having a transmitting device (e.g., handheld radio device) transmit a query of one or more dual-tone multi-frequency signals over a communication channel (e.g., radio channel) to a receiving device. In one embodiment, such a communication channel corresponds to a voice channel of 300-3,000 Hz, which is utilized by almost all first responders. The communication channel (e.g., radio channel) is verified as being open and usable upon receipt by the transmitting device of an acknowledgement of the receipt of the query of the dual-tone multi-frequency signals from the receiving device. In one embodiment, such an acknowledgement corresponds to a sequence of dual-tone multi-frequency signals. In one embodiment, the dual-tone multi-frequency signals utilize a 697 Hz-1633 Hz dual framework. These and other features will be discussed in further detail below.

While the following discusses the present disclosure in connection with utilizing dual-tone multi-frequency technology, the principles of the present disclosure may utilize other in-band audio analog/digital signaling technology. A person of ordinary skill in the art would be capable of applying the principles of the present disclosure to such implementations. Furthermore, embodiments applying the principles of the present disclosure to such implementations would fall within the scope of the present disclosure.

In some embodiments of the present disclosure, the present disclosure comprises a method, system and computer program product for verifying a communication channel (e.g., radio channel) being open and usable. In one embodiment of the present disclosure, a query of one or more dual-tone multi-frequency signals (DTMF signals) is transmitted by a transmitting device (e.g., handheld radio device), such as a transmitting device operated by a first responder, over a communication channel (e.g., radio channel) to a receiving device (e.g., handheld radio device), such as a receiving device operated by a different first responder. A communication channel (also referred to herein as simply “channel”), as used herein, refers to a logical connection over a multiplexed medium, such as a radio channel in telecommunications and computer networking. In one embodiment, first responders (someone designated or trained to respond to an emergency) utilize handheld radio devices to communicate with others, including communicating with other first responders. In one embodiment, such first responders utilize a “voice grade” channel to communicate, which is used by the transmitting device to transmit the query of one or more dual-tone multi-frequency signals. A voice grade channel, as used herein, refers to a channel which provides voice frequency transmission capability in the nominal frequency range of 300 to 3,000 Hz, where the Federal Communications Commission has stipulated the bandwidth requirement for voice grade access to a minimum frequency range of 300 Hz to 3,000 Hz. In one embodiment, the voice grade bandwidth permits the reliable transmission of dual-tone multi-frequency signals or tones (also referred to as “touch tones”). An acknowledgement of a reception of the query of one or more dual-tone multi-frequency (DTMF) signals from the receiving device (e.g., handheld radio device) is received by the transmitting device (e.g., handheld radio device) thereby verifying that the communication channel (e.g., radio channel) is open and usable. In one embodiment, such an acknowledgement corresponds to a sequence of dual-tone multi-frequency signals. In one embodiment, the dual-tone multi-frequency signals utilize a 697 Hz-1633 Hz dual framework. In this manner, communication failures may be reduced in mission critical communication networks by verifying that a communication channel (e.g., radio channel) is open and usable for essential personnel (e.g., first responders).

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

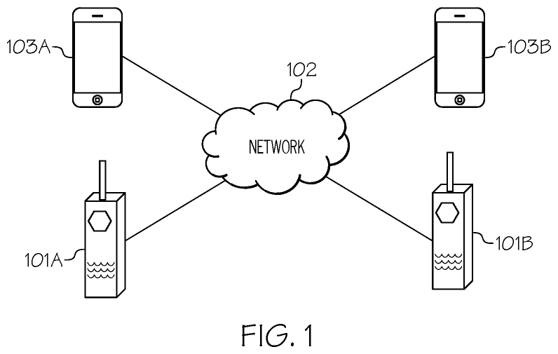

Referring now to the Figures in detail, FIG. 1 illustrates an embodiment of the present disclosure of a communication system 100, such as a mission critical communication system, for practicing the principles of the present disclosure. Communication system 100 includes handheld radio devices 101A, 101B interconnected via a network 102. Handheld radio devices 101A, 101B may collectively or individually be referred to as handheld radio devices 101 or handheld radio device 101, respectively.

Furthermore, as illustrated in FIG. 1, mobile devices 103A, 103B are interconnected via network 102. Mobile devices 103A, 103B may collectively or individually be referred to as mobile devices 103 or mobile device 103, respectively.

Handheld radio devices 101, mobile devices 103 are utilized by first responders (someone designated or trained to respond to an emergency) for communication during an emergency. As used herein, an “originator” refers to the individual who utilizes handheld radio device 101 (e.g., handheld radio device 101A) and/or mobile device 103 (e.g., mobile device 103A) in connection with transmitting one or more dual-tone multi-frequency signals over a communication channel (e.g., radio channel) to a device of the receiver (discussed below) to verify that the communication channel (e.g., radio channel) is open and usable as discussed further below. The “receiver,” as used herein, refers to the individual who utilizes handheld radio device 101 (e.g., handheld radio device 101B) and/or mobile device 103 (e.g., mobile device 103B) in connection with decoding such transmitted dual-tone multi-frequency signals and transmitting an acknowledgement to the device of the originator (e.g., handheld radio device 101A) as discussed further below.

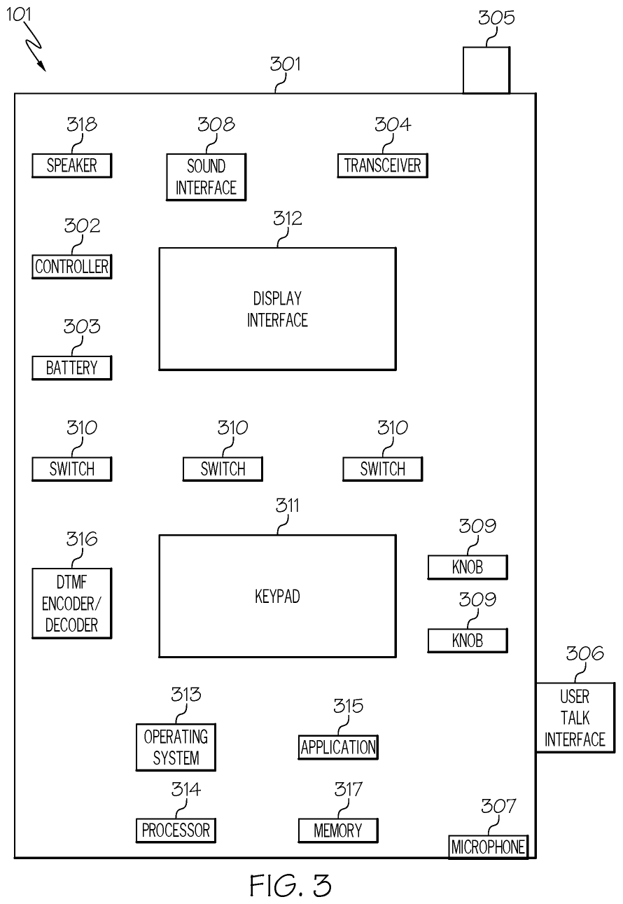

A handheld radio device 101, as used herein, refers to a transmitter/receiver device used for two-way communication based on shortwave radio technology. In one embodiment, such handheld radio devices 101 are utilized by first responders, such as firefighters. Examples of such handheld radio devices 101, include, but not limited to, APX series two-way radios by Motorola Solutions®, XTR300 by Two Way Direct®, Hytera® PD982i, etc. A description of the basic components of such a handheld radio device 101 is discussed below in connection with FIG. 3.

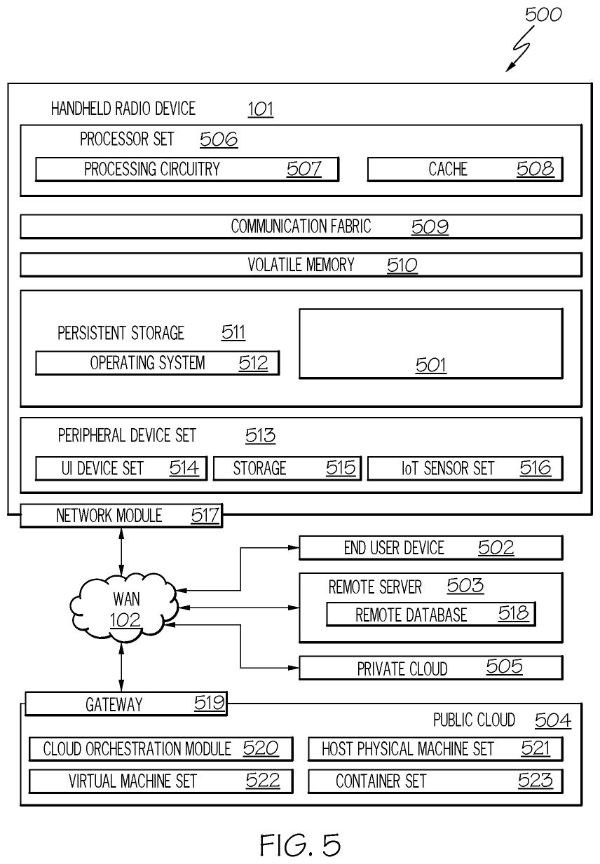

In one embodiment, handheld radio device 101 corresponds to a push-to-talk (PTT) device that combines the utilization of two-way radio and mobile phone technology. A description of a hardware configuration of handheld radio device 101 configured as a PTT device is provided below in connection with FIG. 5.

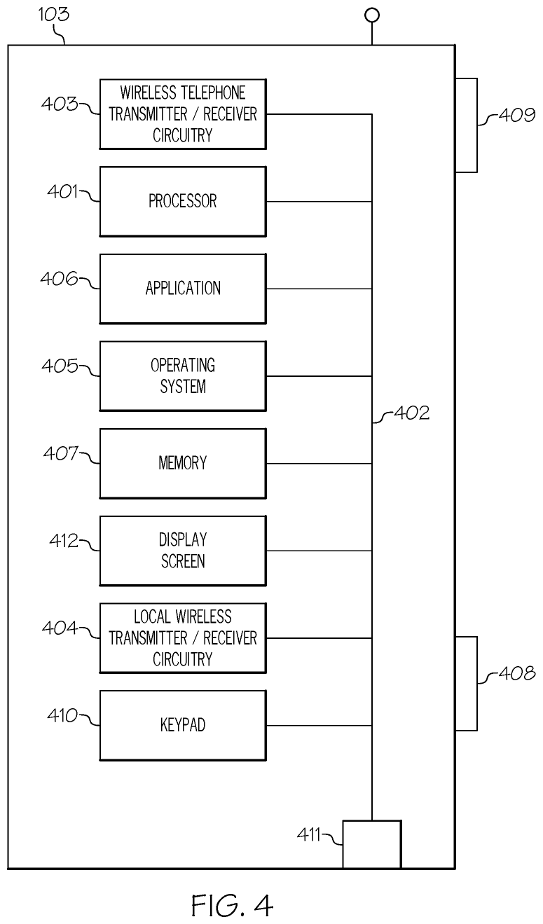

A mobile device 103, as used herein, refers to a computer small enough to hold and operate in the hand. Mobile devices 103 typically have a flat liquid crystal display or organic light emitting diode screen, a touchscreen interface and digital or physical buttons. Examples of such mobile devices 103 include, but not limited to, a mobile phone, a cellular phone, a smartphone, a personal digital assistance (PDA), a portable computing unit, etc. A description of the basic components of such a mobile device 103 is discussed below in connection with FIG. 4.

First responders (someone designated or trained to respond to an emergency) utilize such handheld radio devices 101 to communicate with others, including communicating with other first responders. In one embodiment, such first responders utilize a “voice grade” channel to communicate. A voice grade channel, as used herein, refers to a channel which provides voice frequency transmission capability in the nominal frequency range of 300 to 3,000 Hz, where the Federal Communications Commission has stipulated the bandwidth requirement for voice grade access to a minimum frequency range of 300 Hz to 3,000 Hz.

In one embodiment, the voice grade bandwidth permits the reliable transmission of dual-tone multi-frequency signals or tones (also referred to as “touch tones”).

As discussed above, communication failures have occurred in mission critical communication networks due in part to the use of disparate communication networks and difficulties in establishing end-to-end communications. In particular, communication failures result from not being able to verify a communication channel (e.g., logical connection over a multiplexed medium, such as a radio channel in telecommunications and computer networking) as being open and usable. For example, at times, it has become unclear as to whether first responders (e.g., firefighters) have received mandatory evacuation orders.

In one embodiment, handheld radio devices 101 are configured to verify that a communication channel (e.g., radio channel) is open and usable for essential personnel (e.g., first responders). In one embodiment, a communication channel is verified as being open and usable for essential personnel (e.g., first responders) by having a transmitting device (e.g., handheld radio device 101A) transmit a query of one or more dual-tone multi-frequency signals over a channel (e.g., radio channel) to a receiving device (e.g., handheld radio device 101B). A “transmitting device,” as used herein, refers to a device (e.g., handheld radio device 101) of the originator that transmits the query of one or more dual-tone multi-frequency signals over a channel. A “receiving device,” as used herein, refers to a device (e.g., handheld radio device 101) of the receiver that receives such a transmitted query. It is noted for clarity that any handheld radio device 101 may be the transmitting device or the receiving device and that a particular handheld radio device 101 may either be a transmitting device or a receiving device based on whether such a handheld radio device 101 is transmitting or receiving signals, respectively.

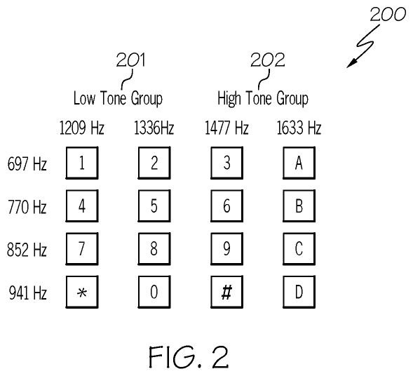

In one embodiment, the transmitting device (e.g., handheld radio device 101A) transmits the query of one or more dual-tone multi-frequency signals over a channel corresponding to the voice channel of 300-3,000 Hz, which is utilize by almost all first responders. In one embodiment, the channel (e.g., radio channel) is verified as being open and usable upon receipt by the transmitting device (e.g., handheld radio device 101A) of an acknowledgement from the receiving device (e.g., handheld radio device 101B), where the acknowledgement acknowledges the receipt of the query of the dual-tone multi-frequency signals. In one embodiment, such an acknowledgement corresponds to a sequence of dual-tone multi-frequency signals. In one embodiment, a 697 Hz-1633 Hz dual framework is utilized for the transmission of such dual-tone multi-frequency signals as illustrated in FIG. 2.

Referring to FIG. 2, FIG. 2 illustrates the 697 Hz-1633 Hz dual framework utilized by handheld radio devices 101 to determine if a communication channel (e.g., radio channel) is open and usable in accordance with an embodiment of the present disclosure.

As shown in FIG. 2, the dual framework corresponds to the dual-tone multi-frequency (DTMF) telephone keypad 200, which is laid out as a matrix of push buttons in which each row represents the low frequency component (697 Hz-941 Hz) and each column (1209 Hz-1633 Hz) represents the high frequency component of the DTMF signal. In one embodiment, the high frequency component of the DTMF signal is divided into the low tone group 201 (1209 Hz-1336 Hz) and the high tone group 202 (1477 Hz-1633 Hz) as shown in FIG. 2.

In one embodiment, the dual framework includes the four rows and the first three columns (without the keys A-D). In another embodiment, the fourth column (keys A-D) is present as shown in FIG. 2. In one embodiment, pressing a key sends a combination of the row and column frequencies (or “dual” tones). For example, the “1” key produces a superimposition of a 697 Hz low tone and a 1209 Hz high tone. That is, the “1” key results in a signal encoded as a pair of sinusoidal (sine wave) tones as shown in FIG. 2 which are mixed with each other using an encoder within handheld radio device 101.

Returning to FIG. 1, in conjunction with FIG. 2, in one embodiment, such DTMF tones are decoded by a decoder of handheld radio device 101 to determine the keys pressed as discussed further below. In one embodiment, such DTMF tones are generated automatically by a tone generator, such as within handheld radio device 101 or mobile device 103 as discussed further below.

In one embodiment, the transmitting device (e.g., handheld radio device 101A) transmits the query of one or more dual-tone multi-frequency signals over a communication channel, corresponding to the voice channel of 300-3,000 Hz, based on the user of the transmitting device pressing the keys (e.g., pressing the keys of “1,” 2,” and “3”) on the keypad of the transmitting device (e.g., handheld radio device 101A), which is encoded as a pair of sinusoidal (sine wave) tones by an encoder of the transmitting device. In another embodiment, the one or more dual-tone multi-frequency signals that are transmitted by the transmitting device (e.g., handheld radio device 101A) over the channel are generated by a tone generator of the transmitting device (e.g., handheld radio device 101A). In another embodiment, the one or more dual-tone multi-frequency signals that are transmitted by the transmitting device (e.g., handheld radio device 101A) over the communication channel are based on a microphone of the transmitting device (e.g., handheld radio device 101A) recording the sounds of the DTMF tones being generated by a nearby mobile device 103, such as the speaker output of mobile device 103 (e.g., mobile device 103A), as discussed further below.

In one embodiment, the one or more dual-tone multi-frequency signals that are transmitted by the transmitting device (e.g., handheld radio device 101A) reflect particular individuals, groups, or be completely arbitrary.

In one embodiment, the transmitting device (e.g., handheld radio device 101A) transmits the query of one or more dual-tone multi-frequency signals over a communication channel using any type of carrier technology (e.g., phase shift keying (PSK), amplitude shift keying (ASK), amplitude modulation, frequency modulation, etc.).

In one embodiment, the receiving device (e.g., handheld radio device 101B) identifies the transmitted query of one or more dual-tone multi-frequency signals over a communication channel (e.g., radio voice channel) by a decoder within the receiving device (e.g., handheld radio device 101B) or aurally.

In one embodiment, the receiving device (e.g., handheld radio device 101B) identifies the transmitted query of one or more dual-tone multi-frequency signals over a communication channel (e.g., radio voice channel) by an audio application on a nearby mobile device 103 (e.g., mobile device 103B) as discussed further below

In one embodiment, upon receipt of the query of one or more dual-tone multi-frequency signals from the transmitting device (e.g., handheld radio device 101A), the receiving device (e.g., handheld radio device 101B) transmits an acknowledgement to the transmitting device verifying that the communication channel is open and operational.

In one embodiment, the acknowledgment includes a sequence of dual-tone multi-frequency signals, which may be generated by an encoder within the receiving device (e.g., handheld radio device 101B) in a similar manner as the encoder within the transmitting device (e.g., handheld radio device 101A) discussed above. In another embodiment, the acknowledgment includes a sequence of dual-tone multi-frequency signals, which may be generated by an application (e.g., Simply DTMF Tone Generator) on a nearby mobile phone 103 (e.g., mobile device 103B), the sounds of which are outputted by the speaker of mobile device 103 and recorded by the microphone of the receiving device (e.g., handheld radio device 101B).

In one embodiment, the acknowledgement is transmitted by the receiving device (e.g., handheld radio device 101B) over the same channel as the query of the one or more dual-tone multi-frequency signals was transmitted by the transmitting device (e.g., handheld radio device 101A). In another embodiment, the acknowledgement is transmitted by the receiving device (e.g., handheld radio device 101B) over a different communication channel than the communication channel utilized by the transmitting device (e.g., handheld radio device 101A) to transmit the query of the one or more dual-tone multi-frequency signals.

In one embodiment, the mobile device 103 (e.g., mobile device 103B) of the receiver (individual who utilizes the receiving device) also detects the transmitted query of one or more dual-tone multi-frequency signals over a communication channel (e.g., radio voice channel), such as via a microphone that records the query of the one or more dual-tone multi-frequency signals outputted by the speaker of the receiving device (e.g., handheld radio device 101B). In one embodiment, an additional acknowledgement to the acknowledgement provided by the receiving device (e.g., handheld radio device 101B) discussed above is generated by an encoder of mobile device 103 (e.g., mobile device 103B) and transmitted to mobile device 103 (e.g., mobile device 103A) of the originator (individual who utilizes the transmitting device) thus providing a redundant, parallel channel of acknowledgement, as discussed further below.

In one embodiment, the receiving device (e.g., handheld radio device 101B) responds to the query of one or more dual-tone multi-frequency signals based on the status of a device of a first responder in communication with the receiving device, such as the status of an oxygen tank, a heart monitor, an automated external defibrillator, etc.

Furthermore, as shown in FIG. 1, handheld radio devices 101 and mobile devices 103 are interconnected via network 102. Network 102 may be, for example, a radio network, a mobile network, a cellular network, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

A further discussion regarding these and other features will be discussed below.

System 100 is not to be limited in scope to any one particular network architecture. System 100 may include any number of handheld radio devices 101, networks 102 and mobile devices 103.

A discussion regarding the basic components of handheld radio device 101 is provided below in connection with FIG. 3.

FIG. 3 illustrates the basic components of handheld radio device 101 in accordance with an embodiment of the present disclosure.

Referring now to FIG. 3, handheld radio device 101 includes a ruggedized body 301 that is compliant with, or similar to, the United States Military Standard of Environmental Engineering Considerations and Laboratory Tests (MIL-STD-810) standard, and utilizes common specifications for battery and other external accessories. Furthermore, as shown in FIG. 3, handheld radio device 101 includes at least an internal controller 302 operative to control the operation of the internal and external components of handheld radio device 101 and an internal battery 303 operative to supply electricity to the electrically operated components of handheld radio device 101. In lieu of an internal battery 303, the battery may be attached to handheld radio device 101. In one embodiment, handheld radio device 101 additionally may include a vibrator, an accelerometer, a gyroscope, a magnetometer, and a global positioning system (“GPS”) interface housed in body 301 and connected to controller 302.

In one embodiment, handheld radio device 101 has a communications system that implements the functionality of existing military, government, or first responder two-way tactical radio communication devices that utilize multiple VHF/UHF or cellular frequency bands, and may utilize a software defined radio architecture. The communications system includes a full- or half-duplex radio communications transceiver 304 as well as an antenna 305. Antenna 305 may be defined by a whip or telescoping antenna extending distally from the radio's form factor, while in others, antenna 305 is replaced via a common connector to a corded external antenna.

In one embodiment, a communication transmission method of handheld radio device 101 is via mechanical push-to-talk (“PTT”) methods by utilizing a user talk interface 306 which may be defined by a physical momentary switch button located on the radio's body to activate an integrated microphone 307 when pressed. User talk interface 306 may also be defined by an externally corded or wireless PTT device. In either implementation, user talk interface 306 may or may not utilize voice-operated transmit (“VOX”) or switch technology.

In one embodiment, electrical audio signals are transduced utilizing a sound interface 308, which may be defined by an integrated loudspeaker on the radio's body. Alternatively, sound interface 308 may be defined by an externally connected loudspeaker. It is contemplated that sound interface 308 may be either independent from the radio's microphonics, or a part of a headset microphone/headphone combination.

Mechanical tactile interfaces of handheld radio device 101 include external tuning knobs 309 and switches 310 for the control of volume, channels, frequencies, or squelch. Mechanical tactile interfaces may also include integrated input switches using non-capacitive buttons on an integrated silicone rubber, plastic, or metallic keypad 311.

In one embodiment, handheld radio device 101 includes a display interface 312 integrated to the radio's body 301. In one embodiment, display interface 312 employs non-capacitive sensing display features, utilizing thin-film optics, including liquid crystal displays (“LCDs”), segment displays, dot-matrix displays, or light-emitting diode (“LED”) displays (traditional or organic).

Utilizing an embedded software-defined radio architecture and an assessment software application, handheld radio device 101 is operative to verify a communication channel (e.g., radio channel) as being open and usable as discussed further below. All or some of the assessment software application may be programmed into or otherwise stored on handheld radio device 101 or may be accessible to handheld radio device 101 through network 102 to which handheld radio device 101 can connect.

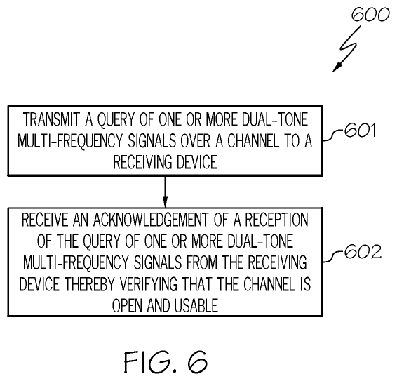

Furthermore, as illustrated in FIG. 3, handheld radio device includes an operating system 313 that runs on processor 314 and provides control and coordinates the functions of the various components of FIG. 3. An application 315 in accordance with the principles of the present disclosure runs in conjunction with operating system 313 and provides calls to operating system 313 where the calls implement the various functions or services to be performed by application 315. Application 315 of handheld radio device 101 may include, for example, a program for verifying the communication channel (e.g., radio channel) as being open and usable as discussed further below in connection with FIGS. 6-10. Furthermore, in one embodiment, application 315 of handheld radio device 101 includes an encoder for encoding a pair of sinusoidal (sine wave) tones which are transmitted as dual-tone multi-frequency signals. Examples of such an encoder include, but not limited to, DTMF Encoder by Polar Electric, etc. In one embodiment, such an encoder is implemented in hardware (DTMF Encoder/Decoder 316), such as DTMF V1 by Jolooyo®. Furthermore, in one embodiment, application 315 of handheld radio device 101 includes a decoder for decoding the dual-tone multi-frequency signals. Examples of such a decoder include, but not limited to, DTMF Decoder by Polar Electric, etc. In one embodiment, such a decoder is implemented in hardware (DTMF Encoder/Decoder 316), such as DTMF V1 by Jolooyo®.

Handheld radio device 101 further includes a memory 317 that is configured to store the requisite logic and parameters to control the transceiver circuitry 304 and control the other functions of handheld radio device 101. Memory 317 is generally integrated as part of the handheld radio device circuitry, but may, in some embodiments, include a removable memory, such as a removable disk memory, integrated circuit (IC) memory, a memory card, or the like. Processor 314 and memory 317 also implement the logic and store the settings, preferences, and parameters for handheld radio device 101. It should be noted that software components including operating system 313 and application 315 may be loaded into memory 317, which may be handheld radio device's 101 main memory for execution.

Furthermore, as shown in FIG. 3, handheld radio device 101 includes a microphone 307 and speaker 318 for the user of handheld radio device 101 to speak and listen to callers. Speaker 318 may represent multiple speakers, at least some of which are configured to alert the user to incoming calls or messages.

A discussion regarding the basic components of mobile device 103 is provided below in connection with FIG. 4.

FIG. 4 illustrates the basic components of mobile device 103 in accordance with an embodiment of the present disclosure.

Referring to FIG. 4, mobile device 103 has a processor 401 connected to various other components by a system bus 402.

Mobile device 103 further includes transmitter/receiver circuitry 403 configured to wirelessly send and receive signals to and from network 102 (FIG. 1). Mobile device 103 also includes local wireless transmitter/receiver circuitry 404 configured to wirelessly send and receive short range signals, such as Bluetooth, infrared or Wi-Fi.

Mobile device 103 further includes an operating system 405 that runs on processor 401 and provides control and coordinates the functions of the various components of FIG. 4. An application 406 in accordance with the principles of the present disclosure runs in conjunction with operating system 405 and provides calls to operating system 405 where the calls implement the various functions or services to be performed by application 406. Application 406 of mobile device 103 may include, for example, a program for verifying a communication channel (e.g., radio channel) as being open and usable as discussed further below in connection with FIGS. 6-10. Furthermore, application 406 of mobile device 103 may include, for example, a tone generator, such as Simply DTMF Tone Generator.

Mobile device 103 further includes a memory 407 that is configured to store the requisite logic and parameters to control the transmitter/receiver circuitry 403, 404 and control the other functions of mobile device 103. Memory 407 is generally integrated as part of the mobile device circuitry, but may, in some embodiments, include a removable memory, such as a removable disk memory, integrated circuit (IC) memory, a memory card, or the like. Processor 401 and memory 407 also implement the logic and store the settings, preferences, and parameters for mobile device 103. It should be noted that software components including operating system 405 and application 406 may be loaded into memory 407, which may be mobile device's 103 main memory for execution.

Mobile device 103 also has a microphone 408 and speaker 409 for the user to speak and listen to callers. Speaker 409 may represent multiple speakers, at least some of which are configured to alert the user to incoming calls or messages. A keypad 410 is configured as part of mobile device 103 for dialing telephone numbers and entering data. Mobile device 103 may be configured with a data input/output (I/O) port 411 for downloading data, applications, programs, and other information. In addition, mobile device 103 typically includes a display screen 412 for displaying messages and information about incoming calls or other features of mobile device 103 that use a graphic display.

A discussion regarding the hardware configuration of handheld radio device 101 configured as a PTT device is provided below in connection with FIG. 5.

Referring now to FIG. 5, in conjunction with FIG. 1, FIG. 5 illustrates an embodiment of the present disclosure of the hardware configuration of handheld radio device 101 configured as a PTT device which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the inventive methods, such as verifying a communication channel (e.g., radio channel) as being open and usable. In addition to block 501, computing environment 500 includes, for example, handheld radio device 101, network 102, such as a wide area network (WAN), end user device (EUD) 502, remote server 503, public cloud 504, and private cloud 505. In this embodiment, handheld radio device 101 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Handheld radio device 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically handheld radio device 101, to keep the presentation as simple as possible. Handheld radio device 101 may be located in a cloud, even though it is not shown in a cloud in FIG. 5. On the other hand, handheld radio device 101 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto handheld radio device 101 to cause a series of operational steps to be performed by processor set 506 of handheld radio device 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of handheld radio device 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In handheld radio device 101, the volatile memory 510 is located in a single package and is internal to handheld radio device 101, but, alternatively or additionally, the volatile memory may be distributed over multiple packages and/or located externally with respect to handheld radio device 101.

Persistent Storage 511 is any form of non-volatile storage for computers that is now known or to be developed in the future. The non-volatility of this storage means that the stored data is maintained regardless of whether power is being supplied to handheld radio device 101 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of handheld radio device 101. Data communication connections between the peripheral devices and the other components of handheld radio device 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where handheld radio device 101 is required to have a large amount of storage (for example, where handheld radio device 101 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows handheld radio device 101 to communicate with other computers through WAN 102. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to handheld radio device 101 from an external computer or external storage device through a network adapter card or network interface included in network module 517.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates handheld radio device 101), and may take any of the forms discussed above in connection with handheld radio device 101. EUD 502 typically receives helpful and useful data from the operations of handheld radio device 101. For example, in a hypothetical case where handheld radio device 101 is designed to provide a recommendation to an end user, this recommendation would typically be communicated from network module 517 of handheld radio device 101 through WAN 102 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to handheld radio device 101. Remote server 503 may be controlled and used by the same entity that operates handheld radio device 101. Remote server 503 represents the machine(s) that collect and store helpful and useful data for use by other computers, such as handheld radio device 101. For example, in a hypothetical case where handheld radio device 101 is designed and programmed to provide a recommendation based on historical data, then this historical data may be provided to handheld radio device 101 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 102 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

As stated above, mission critical communications encompass a wide range of solutions that include a mix of devices, equipment, systems, and infrastructure that enable first responders and others to communicate efficiently and effectively in the field. Mission critical communications provide the ability to coordinate response activities, helping to keep teams connected, communicating, and informed. Without the right mix of public safety communications, lives could be at stake. Since the 1930s, mission critical communications have relied mainly on land mobile radio (LMR). LMR systems consist of handheld radios (also known as “push-to-talk”), vehicle radios, base station radios, networks, and repeaters. However, in recent years, mission critical communication network providers have begun including new solutions, devices, equipment, and infrastructure that provide greater resiliency. Thanks to the rise of satellite networks, long term evolution (LTE) networks, such as FirstNet, and 4G and 5G broadband, mission critical networks now support: push-to-video, video sharing, file sharing, GPS location sharing, laptop computers, tablets, wireless earpieces, etc. Unfortunately, communication failures have occurred in such mission critical communication networks due in part to the use of disparate communication networks and difficulties in establishing end-to-end communications. In particular, communication failures result from not being able to verify a communication channel (e.g., logical connection over a multiplexed medium, such as a radio channel in telecommunications and computer networking) as being open and usable. For example, at times, it has become unclear as to whether first responders (e.g., firefighters) have received mandatory evacuation orders.

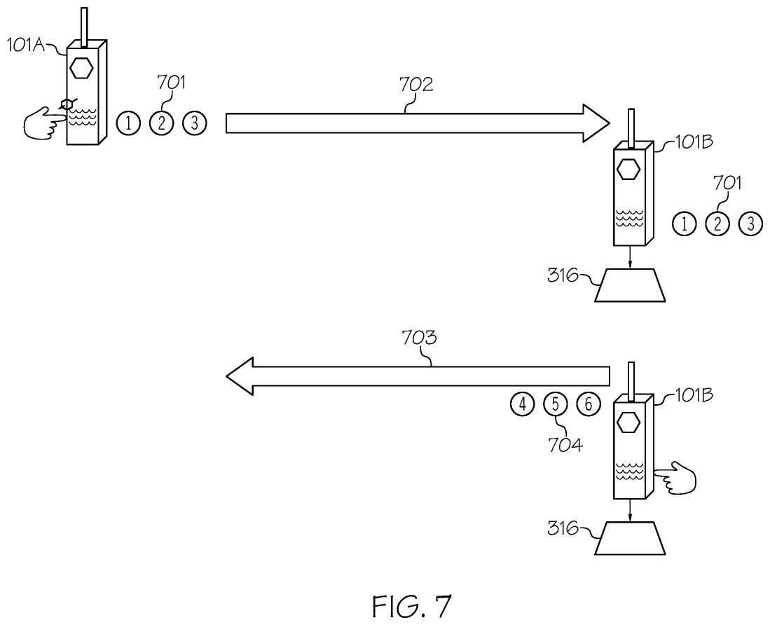

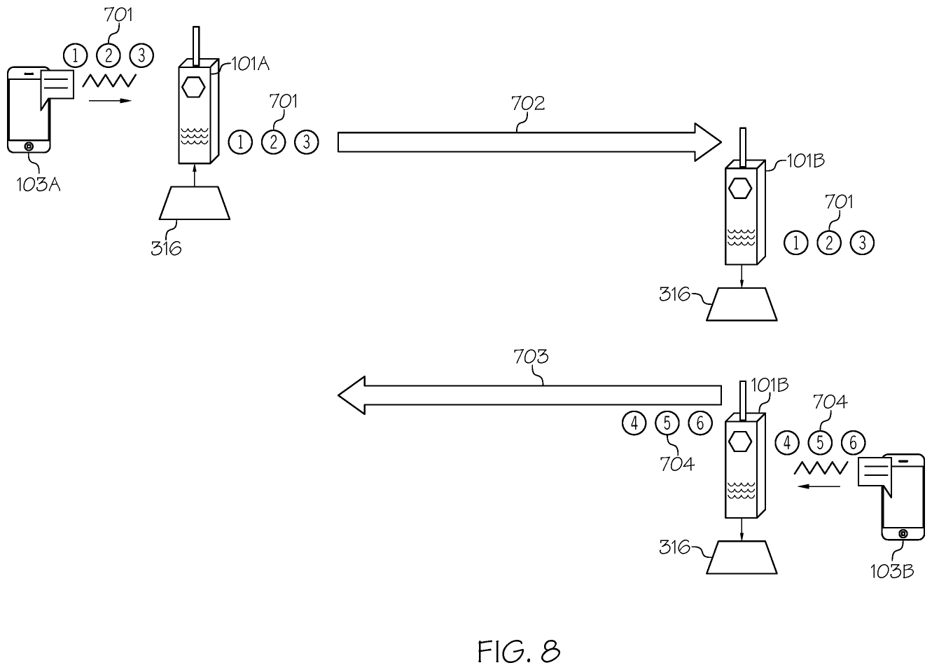

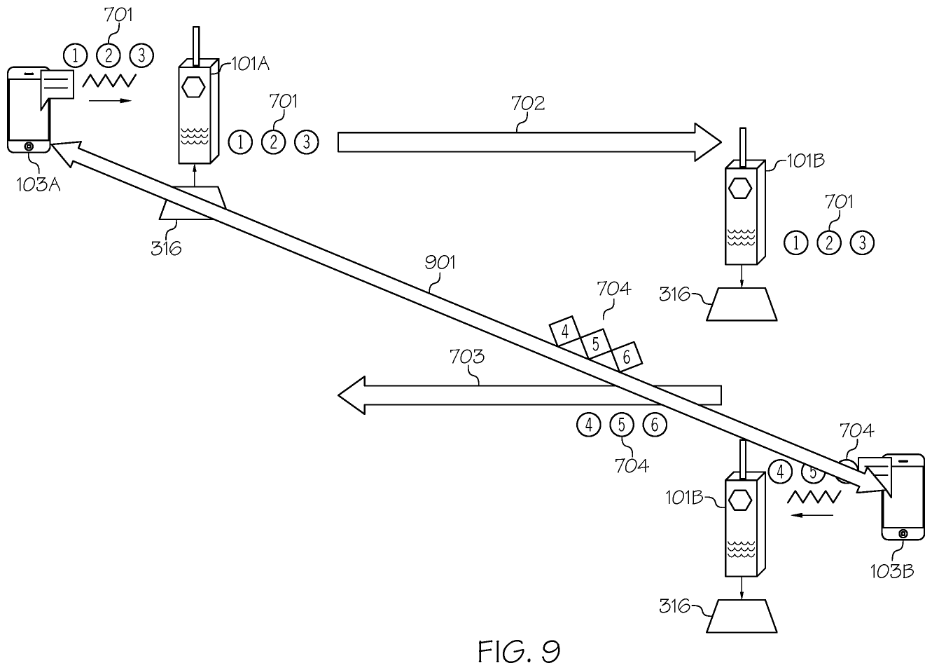

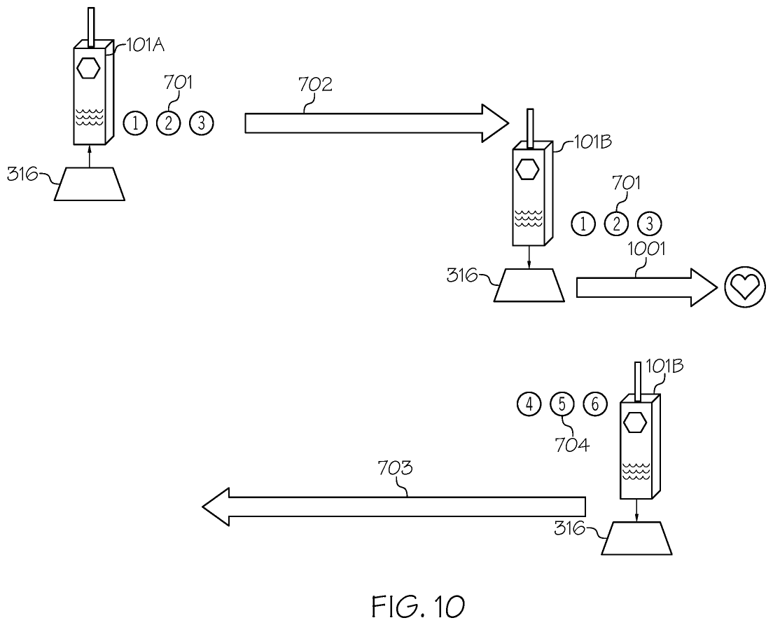

The embodiments of the present disclosure provide a means for reducing communication failures in mission critical communication networks by verifying that a communication channel (e.g., radio channel) is open and usable for essential personnel (e.g., first responders) as discussed below in connection with FIGS. 6-10. FIG. 6 is a flowchart of a method for verifying that a communication channel (e.g., radio channel) is open and usable for essential personnel (e.g., first responders). FIG. 7 is a diagram illustrating manually entering dual-tone multi-frequency signals by the originator and recipient. FIG. 8 is a diagram illustrating the automatic generation of tone sequences by the originator and/or the recipient. FIG. 9 is a diagram illustrating the use of a mobile device (e.g., mobile device 103) to provide a redundant, parallel channel of the acknowledgement. FIG. 10 is a diagram illustrating the verification of the status of a device in communication with the receiving device.

As stated above, FIG. 6 is a flowchart of a method 600 for verifying that a communication channel (e.g., radio channel) is open and usable for essential personnel (e.g., first responders) in accordance with an embodiment of the present disclosure.

Referring to FIG. 6, in conjunction with FIGS. 1-5, in step 601, a query of one or more dual-tone multi-frequency signals (DTMF signals) is transmitted by a transmitting device (e.g., handheld radio device 101A) over a communication channel (e.g., radio channel) to a receiving device (e.g., handheld radio device 101B). A communication channel (also referred to herein as simply “channel”), as used herein, refers to a logical connection over a multiplexed medium, such as a radio channel in telecommunications and computer networking.

As discussed above, a handheld radio device 101, as used herein, refers to a transmitter/receiver device used for two-way communication based on shortwave radio technology. In one embodiment, such handheld radio devices 101 are utilized by first responders, such as firefighters. Examples of such handheld radio devices 101, include, but not limited to, APX series two-way radios by Motorola Solutions®, XTR300 by Two Way Direct®, Hytera® PD982i, etc.

In one embodiment, handheld radio device 101 corresponds to a push-to-talk (PTT) device that combines the utilization of two-way radio and mobile phone technology.

In one embodiment, first responders (someone designated or trained to respond to an emergency) utilize such handheld radio devices 101 to communicate with others, including communicating with other first responders. In one embodiment, such first responders utilize a “voice grade” channel to communicate. A voice grade channel, as used herein, refers to a channel which provides voice frequency transmission capability in the nominal frequency range of 300 to 3,000 Hz, where the Federal Communications Commission has stipulated the bandwidth requirement for voice grade access to a minimum frequency range of 300 Hz to 3,000 Hz.

In one embodiment, the voice grade bandwidth permits the reliable transmission of dual-tone multi-frequency signals or tones (also referred to as “touch tones”).

In one embodiment, handheld radio devices 101 are configured to verify that a communication channel (e.g., radio channel) is open and usable for essential personnel (e.g., first responders). In one embodiment, a communication channel is verified as being open and usable for essential personnel (e.g., first responders) by having a transmitting device (e.g., handheld radio device 101A) transmit a query of one or more dual-tone multi-frequency signals over a communication channel (e.g., radio channel) to a receiving device (e.g., handheld radio device 101B). A “transmitting device,” as used herein, refers to a device (e.g., handheld radio device 101) of the originator that transmits the query of one or more dual-tone multi-frequency signals over a channel. A “receiving device,” as used herein, refers to a device (e.g., handheld radio device 101) of the receiver that receives such a transmitted query. It is noted for clarity that any handheld radio device 101 may be the transmitting device or the receiving device and that a particular handheld radio device 101 may be either a transmitting device or a receiving device based on whether such a handheld radio device 101 is transmitting or receiving signals, respectively.

In one embodiment, the transmitting device (e.g., handheld radio device 101A) transmits the query of one or more dual-tone multi-frequency signals over a communication channel corresponding to the voice channel of 300-3,000 Hz, which is utilize by almost all first responders.

In one embodiment, the one or more dual-tone multi-frequency signals that are transmitted by the transmitting device (e.g., handheld radio device 101A) reflect particular individuals, groups, or be completely arbitrary.

In one embodiment, the transmitting device (e.g., handheld radio device 101A) transmits the query of one or more dual-tone multi-frequency signals over a communication channel using any type of carrier technology (e.g., phase shift keying (PSK), amplitude shift keying (ASK), amplitude modulation, frequency modulation, etc.).

In step 602, an acknowledgement of a reception of the query of one or more dual-tone multi-frequency (DTMF) signals from the receiving device (e.g., handheld radio device 101B) is received by the transmitting device (e.g., handheld radio device 101A) thereby verifying that the communication channel (e.g., radio channel) is open and usable.

As stated above, in one embodiment, the channel (e.g., radio channel) is verified as being open and usable upon receipt by the transmitting device (e.g., handheld radio device 101A) of an acknowledgement of the receipt of the query of the dual-tone multi-frequency signals from the receiving device (e.g., handheld radio device 101B). In one embodiment, such an acknowledgement corresponds to a sequence of dual-tone multi-frequency signals. In one embodiment, a 697 Hz-1633 Hz dual framework is utilized for the transmission of the dual-tone multi-frequency signals as illustrated in FIG. 2.

As shown in FIG. 2, the dual framework corresponds to the dual-tone multi-frequency (DTMF) telephone keypad 200, which is laid out as a matrix of push buttons in which each row represents the low frequency component (697 Hz-941 Hz) and each column (1209 Hz-1633 Hz) represents the high frequency component of the DTMF signal. In one embodiment, the high frequency component of the DTMF signal is divided into the low tone group 201 (1209 Hz-1336 Hz) and the high tone group 202 (1477 Hz-1633 Hz) as shown in FIG. 2.

In one embodiment, the dual framework includes the four rows and the first three columns (without the keys A-D). In another embodiment, the fourth column (keys A-D) is present as shown in FIG. 2. In one embodiment, pressing a key sends a combination of the row and column frequencies (or “dual” tones). For example, the “1” key produces a superimposition of a 697 Hz low tone and a 1209 Hz high tone. That is, the “1” key results in a signal encoded as a pair of sinusoidal (sine wave) tones as shown in FIG. 2 which are mixed with each other using an encoder within handheld radio device 101.

In one embodiment, the receiving device (e.g., handheld radio device 101B) identifies the transmitted query of one or more dual-tone multi-frequency signals over a channel (e.g., radio voice channel) by a decoder within the receiving device (e.g., handheld radio device 101B) or aurally.

In one embodiment, the receiving device (e.g., handheld radio device 101B) identifies the transmitted query of one or more dual-tone multi-frequency signals over a channel (e.g., radio voice channel) by an audio application on a nearby mobile device 103 (e.g., mobile device 103B) as discussed further below

In one embodiment, upon receipt of the query of one or more dual-tone multi-frequency signals from the transmitting device (e.g., handheld radio device 101A), the receiving device (e.g., handheld radio device 101B) transmits an acknowledgement to the transmitting device verifying that the channel is open and operational.

In one embodiment, the acknowledgment includes a sequence of dual-tone multi-frequency signals, which may be generated by an encoder within the receiving device (e.g., handheld radio device 101B) in a similar manner as the encoder within the transmitting device (e.g., handheld radio device 101A) discussed above. In another embodiment, the acknowledgment includes a sequence of dual-tone multi-frequency signals, which may be generated by an application (e.g., Simply DTMF Tone Generator) on a nearby mobile phone 103 (e.g., mobile device 103B), the sounds of which are outputted by the speaker of mobile device 103 and recorded by microphone 307 of the receiving device (e.g., handheld radio device 101B).

In one embodiment, the acknowledgement is transmitted by the receiving device (e.g., handheld radio device 101B) over the same channel as the query of the one or more dual-tone multi-frequency signals was transmitted by the transmitting device (e.g., handheld radio device 101A). In another embodiment, the acknowledgement is transmitted by the receiving device (e.g., handheld radio device 101B) over a different communication channel than the communication channel utilized by the transmitting device (e.g., handheld radio device 101A) to transmit the query of the one or more dual-tone multi-frequency signals.

In one embodiment, mobile device 103 (e.g., mobile device 103B) of the receiver (individual who utilizes the receiving device) also detects the transmitted query of one or more dual-tone multi-frequency signals over a channel (e.g., radio voice channel), such as via microphone 408 that records the query of the one or more dual-tone multi-frequency signals outputted by speaker 318 of the receiving device (e.g., handheld radio device 101B). In one embodiment, an additional acknowledgement to the acknowledgement provided by the receiving device (e.g., handheld radio device 101B) discussed above is generated by an encoder of mobile device 103 (e.g., mobile device 103B) and transmitted to mobile device 103 (e.g., mobile device 103A) of the originator (individual who utilizes the transmitting device) thus providing a redundant, parallel channel of the acknowledgement, as discussed further below.

In one embodiment, the receiving device (e.g., handheld radio device 101B) responds to the query of one or more dual-tone multi-frequency signals based on the status of a device of a first responder in communication with the receiving device, such as the status of an oxygen tank, a heart monitor, an automated external defibrillator, etc.

Various embodiments implementing method 600 are discussed below in connection with FIGS. 7-10.

FIG. 7 is a diagram illustrating manually entering dual-tone multi-frequency signals by the originator and recipient in accordance with an embodiment of the present disclosure.

As shown in FIG. 7, the originator manually inputs one or more dual-tone multi-frequency signals or tones 701 (illustrated as “1,” “2,” and “3” in FIG. 7), such as via keypad 311, microphone 307 or encoder 316. In one embodiment, the originator manually inputs one or more dual-tone multi-frequency signals or tones 701 in mobile device 103 (e.g., mobile device 103A), such as via keypad 410, microphone 408 or an encoder application 406, which is outputted by speaker 409. In such an embodiment, microphone 307 of handheld radio device 101 records the sounds of the dual-tone multi-frequency tones being generated by mobile device 103 (e.g., mobile device 103A), such as via speaker 409.

In one embodiment, the one or more dual-tone multi-frequency signals or tones 701 are transmitted by the originator to the recipient via a channel 702, such as a radio voice channel.

Furthermore, as shown in FIG. 7, the receiving device, such as handheld radio device 101B, identifies the transmitted one or more dual-tone multi-frequency signals or tones 701 via a DTMF decoder 316 of handheld radio device 101B or aurally.

In one embodiment, upon receipt of the query of one or more dual-tone multi-frequency signals from the transmitting device (e.g., handheld radio device 101A), the receiving device (e.g., handheld radio device 101B) transmits an acknowledgement to the transmitting device (e.g., handheld radio device 101A) over channel 703 verifying that channel 702 is open and operational. In one embodiment, channel 703 corresponds to channel 702. In another embodiment, channel 703 corresponds to a different channel 702.

In one embodiment, the acknowledgment includes a sequence of dual-tone multi-frequency signals, which may be generated by an encoder (e.g., DTMF encoder 316) within the receiving device (e.g., handheld radio device 101B) in a similar manner as the encoder (e.g., DTMF encoder 316) within the transmitting device (e.g., handheld radio device 101A) discussed above. In another embodiment, the acknowledgment includes a sequence of dual-tone multi-frequency signals, which may be generated by an application (e.g., Simply DTMF Tone Generator) on a nearby mobile phone 103 (e.g., mobile device 103B), the sounds of which are outputted by speaker 409 of mobile device 103 (e.g., mobile device 103B) and recorded by microphone 307 of the receiving device (e.g., handheld radio device 101B).

In one embodiment, the acknowledgement may include the same sequence of dual-tone multi-frequency signals received from the transmitting device (e.g., handheld radio device 101A), or alternatively, include a different sequence of dual-tone multi-frequency signals or tones 704 (e.g., “4,” “5,” and “6”) as shown in FIG. 7.

FIG. 8 is a diagram illustrating the automatic generation of tone sequences by the originator and/or the recipient in accordance with an embodiment of the present disclosure.

As shown in FIG. 8, the originator's sequence of dual-tone multi-frequency signals or tones 701 and/or the recipient's acknowledgement tones 704 are generated automatically by DTMF encoder/decoder 316 of handheld radio device 101, by an outboard encoder/decoder or by an application 406 (e.g., Simply DTMF Tone Generator, ToneDef) on mobile device 103 generating tones.

For example, as shown in FIG. 8, the originator's sequence of dual-tone multi-frequency signals or tones 701 may be generated by an application 406 (e.g., Simply DTMF Tone Generator) on mobile device 103A. In one embodiment, such tones generated by application 406 of mobile device 103A are outputted by speaker 409 of mobile device 103A and recorded by microphone 307 of handheld radio device 101A. Alternatively, such tones 701 are generated automatically by DTMF encoder/decoder 316 of handheld radio device 101A or by an outboard encoder/decoder.

In one embodiment, the one or more dual-tone multi-frequency signals or tones 701 are transmitted by the originator to the recipient via a channel 702, such as a radio voice channel.

Furthermore, as shown in FIG. 8, the receiving device, such as handheld radio device 101B, identifies the transmitted one or more dual-tone multi-frequency signals or tones 701 via a DTMF decoder 316 of handheld radio device 101B or via an application 406 (e.g., DTMFdec) on mobile device 103B. In one embodiment, application 406 (e.g., DTMFdec) on mobile device 103B identifies the transmitted dual-tone multi-frequency signals or tones 701 based on microphone 411 recording the sounds of the dual-tone multi-frequency signals or tones 701 outputted by speaker 318 of the receiving device (e.g., handheld radio device 101B).

In one embodiment, upon receipt of the query of one or more dual-tone multi-frequency signals from the transmitting device (e.g., handheld radio device 101A), the receiving device (e.g., handheld radio device 101B) transmits an acknowledgement to the transmitting device (e.g., handheld radio device 101A) over channel 703 verifying that channel 702 is open and operational. In one embodiment, channel 703 corresponds to channel 702. In another embodiment, channel 703 corresponds to a different channel 702.

In one embodiment, the acknowledgment includes a sequence of dual-tone multi-frequency signals, which may be generated by an encoder (e.g., DTMF encoder 316) within the receiving device (e.g., handheld radio device 101B) in a similar manner as the encoder (e.g., DTMF encoder 316) within the transmitting device (e.g., handheld radio device 101A) discussed above. In another embodiment, the acknowledgment includes a sequence of dual-tone multi-frequency signals, which may be generated by an application (e.g., Simply DTMF Tone Generator, ToneDef) on a nearby mobile phone 103 (e.g., mobile device 103B), the sounds of which are outputted by speaker 409 of mobile device 103 (e.g., mobile device 103B) and recorded by microphone 307 of the receiving device (e.g., handheld radio device 101B).

In one embodiment, the acknowledgement may include the same sequence of dual-tone multi-frequency signals received from the transmitting device (e.g., handheld radio device 101A), or alternatively, include a different sequence of dual-tone multi-frequency signals or tones 704 (e.g., “4,” “5,” and “6”) as shown in FIG. 8.

FIG. 9 is a diagram illustrating the use of a mobile device (e.g., mobile device 103) to provide a redundant, parallel channel of the acknowledgement in accordance with an embodiment of the present disclosure.

As shown in FIG. 9, in one embodiment, the receiver's mobile device 103B also receives the originator's dual-tone multi-frequency signals or tones 701 (in addition to handheld radio device 101B) via channel 901 across network 102 (e.g., cellular network, WiFi) and provides a duplicate acknowledgement (duplicate of the acknowledgement provided by handheld radio device 101B) via channel 901 across network 102 (e.g., cellular network, WiFi) thus providing a redundant, parallel channel of acknowledgement.

As discussed above, in one embodiment, mobile device 103B includes an application 406 (e.g., DTMFdec) to identify the transmitted one or more dual-tone multi-frequency signals or tones 701. Furthermore, as discussed above, the acknowledgment may be generated by an application 406 (e.g., Simply DTMF Tone Generator, ToneDef) of mobile phone 103B, which is transmitted to the mobile device of the originator (e.g., mobile device 103A), such as via channel 901 across network 102.

In one embodiment, the acknowledgement may include the same sequence of dual-tone multi-frequency signals received from the transmitting device (e.g., handheld radio device 101A), or alternatively, include a different sequence of dual-tone multi-frequency signals or tones 704 (e.g., “4,” “5,” and “6”) as shown in FIG. 9.

FIG. 10 is a diagram illustrating the verification of the status of a device in communication with the receiving device in accordance with an embodiment of the present disclosure.

As shown in FIG. 10, the recipient responds to the originator's series of tones based on circumstances, such as the status of a device (see element 1001) in communication with the receiving device (e.g., handheld radio device 101B). For example, the recipient responds to the originator's series of tones based on circumstances, such as the status of a device (see element 1001) of a first responder in communication with the receiving device (e.g., handheld radio device 101B), such as the status of an oxygen tank, a heart monitor, an automated external defibrillator, etc.

In one embodiment, based on the status of the device (e.g., oxygen tank, heart monitor, automated external defibrillator, etc.) in communication with the receiving device (e.g., handheld radio device 101B), an acknowledgment includes a particular sequence of dual-tone multi-frequency signals generated using the means discussed above. For example, in response to the status of the heart monitor performing correctly, the sequence of “4,” “5,” and “6” may be issued as the acknowledgment; whereas, in response to the status of the heart monitor not performing correctly, the sequence of “7,” “8,” and “9” may be issued as the acknowledgment.

In this manner, the principles of the present disclosure provide a means for reducing communication failures in mission critical communication networks by verifying that a communication channel (e.g., radio channel) is open and usable for essential personnel (e.g., first responders).

Furthermore, the principles of the present disclosure improve the technology or technical field involving mission critical communications. As discussed above, mission critical communications encompass a wide range of solutions that include a mix of devices, equipment, systems, and infrastructure that enable first responders and others to communicate efficiently and effectively in the field. Mission critical communications provide the ability to coordinate response activities, helping to keep teams connected, communicating, and informed. Without the right mix of public safety communications, lives could be at stake. Since the 1930s, mission critical communications have relied mainly on land mobile radio (LMR). LMR systems consist of handheld radios (also known as “push-to-talk”), vehicle radios, base station radios, networks, and repeaters. However, in recent years, mission critical communication network providers have begun including new solutions, devices, equipment, and infrastructure that provide greater resiliency. Thanks to the rise of satellite networks, long term evolution (LTE) networks, such as FirstNet, and 4G and 5G broadband, mission critical networks now support: push-to-video, video sharing, file sharing, GPS location sharing, laptop computers, tablets, wireless earpieces, etc. Unfortunately, communication failures have occurred in such mission critical communication networks due in part to the use of disparate communication networks and difficulties in establishing end-to-end communications. In particular, communication failures result from not being able to verify a communication channel (e.g., logical connection over a multiplexed medium, such as a radio channel in telecommunications and computer networking) as being open and usable. For example, at times, it has become unclear as to whether first responders (e.g., firefighters) have received mandatory evacuation orders.

Embodiments of the present disclosure improve such technology by transmitting a query of one or more dual-tone multi-frequency signals (DTMF signals) by a transmitting device (e.g., handheld radio device), such as a transmitting device operated by a first responder, over a communication channel (e.g., radio channel) to a receiving device (e.g., handheld radio device), such as a receiving device operated by a different first responder. A communication channel (also referred to herein as simply “channel”), as used herein, refers to a logical connection over a multiplexed medium, such as a radio channel in telecommunications and computer networking. In one embodiment, first responders (someone designated or trained to respond to an emergency) utilize handheld radio devices to communicate with others, including communicating with other first responders. In one embodiment, such first responders utilize a “voice grade” channel to communicate, which is used by the transmitting device to transmit the query of one or more dual-tone multi-frequency signals. A voice grade channel, as used herein, refers to a channel which provides voice frequency transmission capability in the nominal frequency range of 300 to 3,000 Hz, where the Federal Communications Commission has stipulated the bandwidth requirement for voice grade access to a minimum frequency range of 300 Hz to 3,000 Hz. In one embodiment, the voice grade bandwidth permits the reliable transmission of dual-tone multi-frequency signals or tones (also referred to as “touch tones”). An acknowledgement of a reception of the query of one or more dual-tone multi-frequency (DTMF) signals from the receiving device (e.g., handheld radio device) is received by the transmitting device (e.g., handheld radio device) thereby verifying that the communication channel (e.g., radio channel) is open and usable. In one embodiment, such an acknowledgement corresponds to a sequence of dual-tone multi-frequency signals. In one embodiment, the dual-tone multi-frequency signals utilize a 697 Hz-1633 Hz dual framework. In this manner, communication failures may be reduced in mission critical communication networks by verifying that a communication channel (e.g., radio channel) is open and usable for essential personnel (e.g., first responders). Furthermore, in this manner, there is an improvement in the technical field involving mission critical communications.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for verifying a communication channel being open and usable, the method comprising:
transmitting a query of one or more dual-tone multi-frequency signals over said communication channel to a receiving device; and
receiving an acknowledgment of a reception of said query of said one or more dual-tone multi-frequency signals from said receiving device thereby verifying said communication channel is open and usable.

2. The method as recited in claim 1, wherein said acknowledgement comprises a sequence of dual-tone multi-frequency signals.

3. The method as recited in claim 2, wherein said one or more dual-tone multi-frequency signals of said query and said sequence of dual-tone multi-frequency signals of said acknowledgment utilize a 697 Hz-1633 Hz dual framework.

4. The method as recited in claim 1, wherein said communication channel comprises a 300-3,000 Hz voice channel.

5. The method as recited in claim 1, wherein said query of said one or more dual-tone multi-frequency signals is transmitted by a first handheld radio device upon receiving said one or more dual-tone multi-frequency signals from a tone generator of said first handheld radio device or a mobile phone.

6. The method as recited in claim 1, wherein said query of said one or more dual-tone multi-frequency signals is identified by a decoder of a second handheld radio device, wherein said acknowledgment of said reception of said query of said one or more dual-tone multi-frequency signals is generated by said second handheld radio device upon receiving said acknowledgement from an encoder of said second handheld radio device or a mobile device.

7. The method as recited in claim 1, wherein said query of said one or more dual-tone multi-frequency signals is transmitted over a first communication channel, wherein said acknowledgement is received over a second communication channel, wherein said first communication channel is different from said second communication channel.

8. The method as recited in claim 1, wherein said acknowledgement is sent from said receiving device in response to verifying a status of a device in communication with said receiving device.

9. A computer program product for verifying a communication channel being open and usable, the computer program product comprising one or more computer readable storage mediums having program code embodied therewith, the program code comprising programming instructions for:
transmitting a query of one or more dual-tone multi-frequency signals over said communication channel to a receiving device; and
receiving an acknowledgment of a reception of said query of said one or more dual-tone multi-frequency signals from said receiving device thereby verifying said communication channel is open and usable.

10. The computer program product as recited in claim 9, wherein said acknowledgement comprises a sequence of dual-tone multi-frequency signals.

11. The computer program product as recited in claim 10, wherein said one or more dual-tone multi-frequency signals of said query and said sequence of dual-tone multi-frequency signals of said acknowledgment utilize a 697 Hz-1633 Hz dual framework.

12. The computer program product as recited in claim 9, wherein said communication channel comprises a 300-3,000 Hz voice channel.

13. The computer program product as recited in claim 9, wherein said query of said one or more dual-tone multi-frequency signals is transmitted by a first handheld radio device upon receiving said one or more dual-tone multi-frequency signals from a tone generator of said first handheld radio device or a mobile phone.

14. The computer program product as recited in claim 9, wherein said query of said one or more dual-tone multi-frequency signals is identified by a decoder of a second handheld radio device, wherein said acknowledgment of said reception of said query of said one or more dual-tone multi-frequency signals is generated by said second handheld radio device upon receiving said acknowledgement from an encoder of said second handheld radio device or a mobile device.

15. The computer program product as recited in claim 9, wherein said query of said one or more dual-tone multi-frequency signals is transmitted over a first communication channel, wherein said acknowledgement is received over a second communication channel, wherein said first communication channel is different from said second communication channel.

16. The computer program product as recited in claim 9, wherein said acknowledgement is sent from said receiving device in response to verifying a status of a device in communication with said receiving device.

17. A system, comprising:
a memory for storing a computer program for verifying a communication channel being open and usable; and
a processor connected to said memory, wherein said processor is configured to execute program instructions of the computer program comprising:
transmitting a query of one or more dual-tone multi-frequency signals over said communication channel to a receiving device; and
receiving an acknowledgment of a reception of said query of said one or more dual-tone multi-frequency signals from said receiving device thereby verifying said communication channel is open and usable.

18. The system as recited in claim 17, wherein said acknowledgement comprises a sequence of dual-tone multi-frequency signals.

19. The system as recited in claim 18, wherein said one or more dual-tone multi-frequency signals of said query and said sequence of dual-tone multi-frequency signals of said acknowledgment utilize a 697 Hz-1633 Hz dual framework.

20. The system as recited in claim 17, wherein said communication channel comprises a 300-3,000 Hz voice channel.
